(19) United States
(12) Patent Application Publication
(10) Pub. No.: US 2008/0315732 A1
(43) Pub. Date: Dec. 25, 2008

(54) Electrically operated lifting cover device for a host computer

(76) Inventor: Vincent Lai, Taoyuan Hsien (TW)

Correspondence Address: PRO-TECHTOR INTERNATIONAL SERVICES, 20775 NORADA CT., SARATOGA, CA, 95070, US

(21) Appl. No.: 11/821,180

(22) Filed: Jun. 22, 2007

(51) Int. Cl. G12B 9/02

(52) U.S. Cl. 312/223.2

(57) ABSTRACT

The present invention is an electrically operated lifting cover device for a host computer, in which a contact switch is installed at a side of a power switch of a case of a host computer. The contact switch is connected to a gear box located on an inner side of the case, and a user touching the contact switch actuates a first connecting rod of a lifting cover by electrical means, which connectively upwardly turns a second connecting rod, thereby enabling raising the lifting cover to the top position of the case.

### BACKGROUND OF THE INVENTION

(a) Field of the Invention

The present invention relates to an electrically operated device used to raise a lifting cover of a host computer.

(b) Description of the Prior Art

A lifting cover additionally installed on a conventional case of a host computer is used to protect the exposed devices of a CD-ROM drive and floppy drive, and provides a more aesthetic appearance to the overall profile. However, because of nonuniform application of force during manual operation to raise the conventional lifting cover easily results in malfunctioning of the lifting cover device.

### SUMMARY OF THE INVENTION

The primary objective of the present invention is to provide an electrically operated lifting cover device for a host computer which is able to electrically raise a lifting cover by merely touching a lifting cover switch, thereby eliminating malfunctioning of the lifting cover caused by people during handling thereof, and thus extending the service life of the lifting cover.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an external appearance of a lifting cover device of the present invention.

FIG. 2 shows a structural schematic view after raising the lifting cover of the present invention.

FIG. 3 shows an external appearance of a rear side of the lifting cover device of the present invention.

FIG. 4 shows a structural schematic view of a gear set of the present invention.

FIG. 5 shows a structural schematic view of a pivot shaft and a stop switch of the present invention.

FIG. 6 shows a structural schematic view of a rear side after raising the lifting cover of the present invention.

### DETAILED DESCRIPTION OF THE PREFERRED EMBODIMENTS

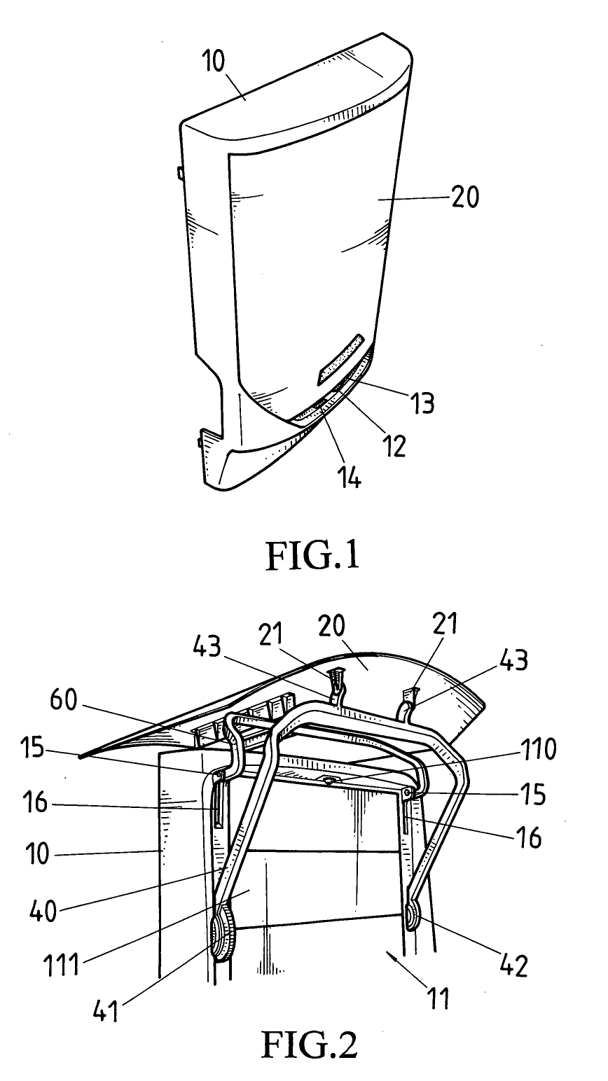

Referring to FIGS. 1 and 2, a host computer of the present invention comprises a case 10 and a lifting cover 20, wherein the case 10 is provided with an opening 11 at a position corresponding to the lifting cover 20. A CD-ROM drive slot 111 and floppy drive slot 112 are provided in the opening 11. An illuminating lamp 110 is provided at a top end of the opening 11, which enables illuminating the CD-ROM drive slot 111 and the floppy drive slot 112, and a power switch 12 and a power source lamp 13 are provided at a lower portion of the opening 11. The present invention is characterized in that:

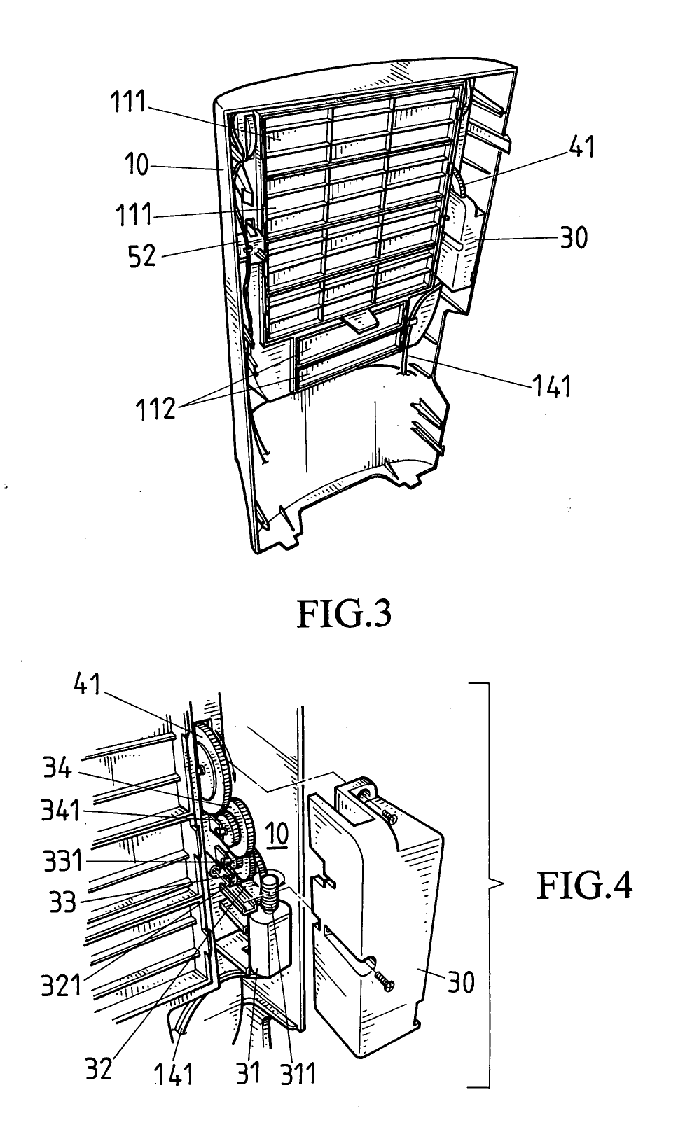

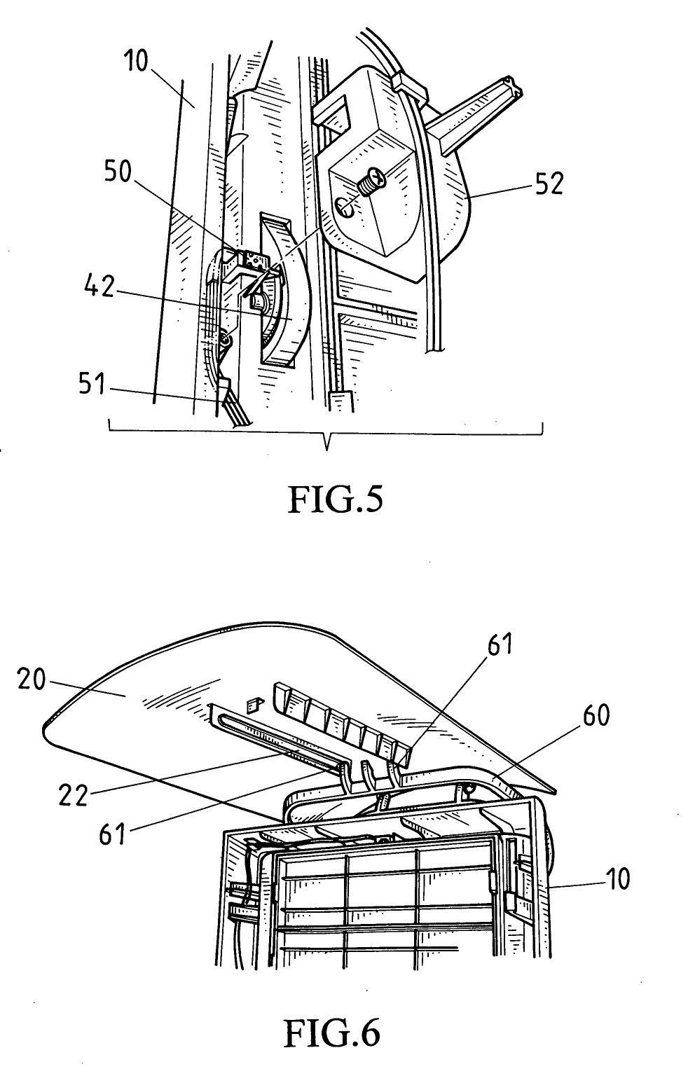

A contact switch 14 is provided at a side of the power switch 12, and touching the contact switch 14 enables raising of the lifting cover 20. Referring to FIGS. 3 and 4, the contact switch 14 is connected to a motor 31 disposed interior of a gear box 30 using an electric wire 141. A gear shaft 311 of the motor 31 is able to drive and rotate a first gear 32, and a pinion gear 321 coaxial with the first gear 32 drives and rotates a second gear 33, and a pinion gear 331 coaxial with the second gear 33 then drives and rotates a third gear 34. A pinion gear 341 coaxial with the third gear 34 then meshes with a gear 41 at one end of a first connecting rod 40, thereby causing the first connecting rod 40 to turn upward. Referring to FIG. 5, when the lifting cover 20 has been raised to the uppermost position, a pivot shaft 42 at the other end of the generally square inverted U-shaped first connecting rod 40 makes contact with a stop switch 50, whereupon the stop switch 50 shuts down the motor 31. One end of the stop switch 50 is connected to a circuit board (not shown in the drawings) located within the case 10 using an electric wire 51. An outer cover 52 is bolted over the pivot shaft 42 and the stop switch 50.

Referring to FIG. 2, two protruding pieces 43 located center of the first connecting rod 40 are respectively bolted to two position fixing strips 21 of a bottom portion of an inner side of the lifting cover 20, thereby joining the first connecting rod 40 to the lifting cover 20 to form an integrated body. Referring to FIG. 6, tracks 22 are located on the inner side of the lifting cover 20, and two slide pieces 61 located center of a second connecting rod 60 respectively slide within the tracks 22 of the lifting cover 20. Two ends of the generally square inverted U-shaped second connecting rod 60 are respectively pin connected to shaft rods 15 of the case 10, and the shaft rods 15 are respectively pin connected to top ends of two slots 16 of the opening 11 of the case 10. The slots 16 are used by bent portions of the second connecting rod 60, thus, when the first connecting rod 40 actuates and raises the lifting cover 20, then the slide pieces 61 of the second connecting rod 60 slide within the tracks 22 of the lifting cover 20, whereupon the second connecting rod 60 simultaneously upwardly turns about the two shaft rods 15 of the case 10 as center, thereby facilitating raising of the lifting cover 20. When the contact switch 14 is touched again, then the lifting cover 20 is actuated and restored to its original position covering the opening 11 of the case 10.

As will be apparent from the foregoing, the present invention facilitates opening of the lifting cover 20 by using a touch method to contact the contact switch 14 on the case 10 of the host computer, thereby eliminating malfunctioning of device components for lifting the cover resulting from conventional manual means to raise the lifting cover.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An electrically operated lifting cover device for a host computer, comprising an opening defined in a case of a host computer provided with a lifting cover device, a power switch is provided at a lower portion of the opening, tracks are located on an inner side of a lifting cover, and shaft rods and slots are provided at two ends of the case; the lifting cover device comprises:
a contact switch positioned at a side of the power switch of the case;
a gear box positioned on an inner side of the case, a motor installed interior of the gear box is connected to the contact switch using an electric wire, a gear shaft of the motor drives at least one set of gears, and pinion gears are coaxially disposed at sides of the gears;
a first connecting rod, a gear at one end of which meshes with a pinion gear of the gear box, a pivot shaft is located at the other end of the first connecting rod, and protruding pieces are located center of the first connecting rod, the protruding pieces are respectively bolted to position fixing strips of a bottom portion of an inner side of the lifting cover;
a second connecting rod, slide pieces at a center of which slide within the tracks of the lifting cover, two ends of the second connecting rod are pin connected to the shaft rods of the case, sections of the structure of the second connecting rod are bent to fit into the slots of the case;
a stop switch installed at an end of the case, thus, when the lifting cover has been raised to the uppermost position, the pivot shaft of the first connecting rod makes contact with the stop switch, thereby shutting down the motor.

2. The electrically operated lifting cover device for a host computer according to claim 1, wherein an end of the stop switch is connected to a circuit board within the case using an electric wire.

3. The electrically operated lifting cover device for a host computer according to claim 1, wherein an outer cover is bolted over the stop switch.
